(19) United States
(12) Patent Application Publication
(10) Pub. No.: US 2010/0157081 A1
(43) Pub. Date: Jun. 24, 2010

(54) RENDERING SYSTEM AND DATA PROCESSING METHOD USING SAME

(75) Inventors: Hye-Sun KIM, Daejeon (KR); Yun Ji Ban, Daejeon (KR); Chung Hwan Lee, Daejeon (KR); Seung Woo Nam, Daejeon (KR)

Correspondence Address: STAAS & HALSEY LLP, SUITE 700, 1201 NEW YORK AVENUE, N.W., WASHINGTON, DC, 20005, US

(73) Assignee: ELECTRONICS AND TELECOMMUNICATIONS RESEARCH INSTITUTE, Daejeon (KR)

(21) Appl. No.: 12/538,539

(22) Filed: Aug. 10, 2009

(30) Foreign Application Priority Data
Dec. 22, 2008 (KR) 10-2008-0131770

(51) Int. Cl. H04N 5/232; H04N 5/228; G06T 15/00

(52) U.S. Cl. 348/222.1; 345/419; 348/E05.045

(57) ABSTRACT

A rendering system includes a data input unit for reading depth information of a deep render buffer obtained by rendering; a camera lens sampling unit for sampling surface data of a lens provided in a camera; a deep render buffer reconstruction unit referring to pixel location information of the deep render buffer to reconstruct a deep render buffer at a new camera position, wherein the camera position corresponds to a sampling result from the camera lens sampling unit. The rendering system further includes a render image generation unit for generating a render image at the camera position from the reconstructed deep render buffer; and an image accumulation unit for accumulating the render image at the camera position.

### CROSS-REFERENCE(S) TO RELATED APPLICATIONS

The present invention claims priority of Korean Patent Application No. 10-2008-0131770, filed on Dec. 22, 2008, which is incorporated herein by reference.

### FIELD OF THE INVENTION

The present invention relates to a rendering system and data processing method thereof, which relies on a deep render buffer provided for hair rendering to render depth of field, hereinafter referred to as ‘DOF’.

### BACKGROUND OF THE INVENTION

As performance of computers improves in recent years, three dimensional (3-D) computer graphics technology is widely adopted in numerous fields such as film making, advertisement, games and animations. Owing to development in graphics technology, it is made possible to create images identical to or almost approaching actually captured images, and as a result, photorealistic image representation techniques are ever more required.

However, photorealistic image representation often demands massive amount of data and high-end computer systems for rendering job. Moreover, creation of such images costs an enormous time for computation and designer's work. Such a problem is addressed by many recent studies and technology development.

Among numerous methods of improving the quality of rendered images, a 3-D rendering DOF representation is a method which portrays in 3-D rendering work a DOF phenomenon being observed with an actual lens. The DOF phenomenon indicates a situation where distant objects appear as blurred while objects located close to focal distance are viewed clearly. This phenomenon is caused by a convexly shaped volume of camera lens.

The DOF phenomenon is not found at pinhole cameras used in 3-D rendering which is only provided with a tiny hole without any lens. Known techniques commonly used for realizing a DOF effect in 3-D rendering work include a 3-D DOF method which simulates an actual lens and synthesizes rendering results from respective sampling points on the surface of lens, and a 2-D DOF approximation method where a rendered image is blurred at each pixel by comparing depth information of the pixel and the focal distance.

Traditional DOF processing methods for 3-D rendering are detailedly illustrated in an article entitled “A Lens and Aperture Camera Model for Synthetic Image Generation” published in 1981 and “Real-Time, Accurate Depth of Field using Anisotropic Diffusion and Programmable Graphics Cards” published in 2004.

Considering that relatively long time is required even for rendering of a single image which involves processing of millions of hair data, the traditional 3-D DOF representation method for hair data rendering has a problem of requiring overlong rendering time to realize DOF representation, for the method includes many times of conducting 3-D rendering process.

### SUMMARY OF THE INVENTION

It is an object of the present invention to provide a rendering system and a data processing method thereof which enable DOF representation of hair data using hair rendering information in a deep render buffer generated in the course of hair rendering, along with a focal distance of a camera.

In accordance with an aspect of the present invention, there is provided a rendering system, which includes a data input unit for reading depth information of a deep render buffer obtained by rendering, a camera lens sampling unit for sampling surface data of a lens provided in a camera, a deep render buffer reconstruction unit referring to pixel location information of the deep render buffer to reconstruct a deep render buffer at a new camera position, wherein the camera position corresponds to a sampling result from the camera lens sampling unit, a render image generation unit for generating a render image at the camera position from the reconstructed deep render buffer, and an image accumulation unit for accumulating the render image at the camera position.

In accordance with another aspect of the present invention, there is provided a data processing method of a rendering system, which includes generating a first deep render buffer from data rendering, reconstructing a second deep render buffer according to a sampling position of a camera using the first deep render buffer, and producing a depth-of-field render image by accumulating render images created at the sampling position.

The present invention, different from traditional methods where DOF is portrayed by rending massive hair data many times at diverse positions of a lens, relies on deep render buffer data in order to achieve a fast and effective portraying of DOF in hair data.

### BRIEF DESCRIPTION OF THE DRAWINGS

The above and other objects and features of the present invention will become apparent from the following description of embodiments, given in conjunction with the accompanying drawings, in which:

FIG. 1 is a block diagram showing general constitution of a rendering system in accordance with an aspect of the present invention;

FIG. 2 shows a data processing procedure of a rendering system in accordance with another aspect of the present invention; and

FIG. 3 illustrates a deep render buffer employed in an embodiment of the present invention.

### DETAILED DESCRIPTION OF THE EMBODIMENTS

Hereinafter, embodiments of the present invention will be described in detail with reference to the accompanying drawings so that they can be readily implemented by those skilled in the art.

It should be acknowledged that the hair data as an object of the rendering in accordance with the present invention are required to be large in number of subjects and cannot be represented by a render buffer solely consisting of a 2-D plane due to their opaque characteristics. They may be represented by a so-called deep render buffer where each pixel in a 2-D plane has a list which contains a large amount of additional pixel information sorted by depth.

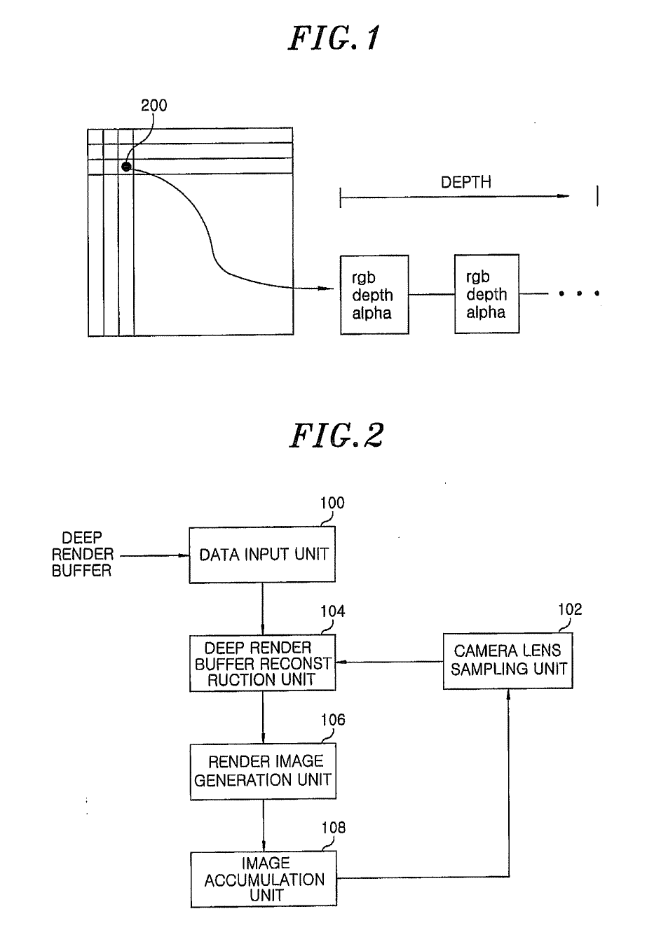

Such a deep render buffer is, as depicted in FIG. 1, differentiated from a traditional 2-D planar buffer which represents for each pixel a rendering object located foremost, in that each pixel is provided with a list including, as well as the foremost one, the rendering objects located behind being sorted in depth order. The deep render buffer has, for a node in the first pixel as an example, values for a depth, a color represented in RGB format and an alpha.

The block diagram of FIG. 2 illustrates a rendering system for hair data DOF representation in accordance with an aspect of the present invention, which includes a data input unit 100, a camera lens sampling unit 102, a deep render buffer reconstruction unit 104, a render image generation unit 106 and an image accumulation unit 108.

As illustrated in FIG. 2, the data input unit 100 receives as an input a deep render buffer generated as a result of rendering, i.e., deep render buffer information after rendering is done at an initial camera position as well as reading depth information of the deep render buffer.

The camera lens sampling unit 102 is configured to generate sampling position information of a pinhole camera (not shown) by sampling points on the camera lens surface according to an actual lens' focal distance and aperture, in the same manner as a traditional 3-D DOF method.

The deep render buffer reconstruction unit 104 refers to pixel location information of the deep render buffer obtained as a result of rendering at a former camera position to generate new location information indicating where the former buffer pixels are to be located at a new camera sampling position, and reconstructs a new deep render buffer therefrom. Here, the former buffer pixel information may be required to move in a measure according to information of the new camera.

Meanwhile, the render image generation unit 106 functions to compress a deep render buffer having depth information into a normal 2-D image buffer. The pixel information of a deep render buffer is employed in the procedure of determining projection level of pixels located behind and then the buffer is compressed into 2-D image values.

The Image accumulation unit 108 operates to display blurring effect according to focal distance of a camera by means of accumulating images generated in the course of deep render buffer reconstruction at the respective camera lens sampling positions.

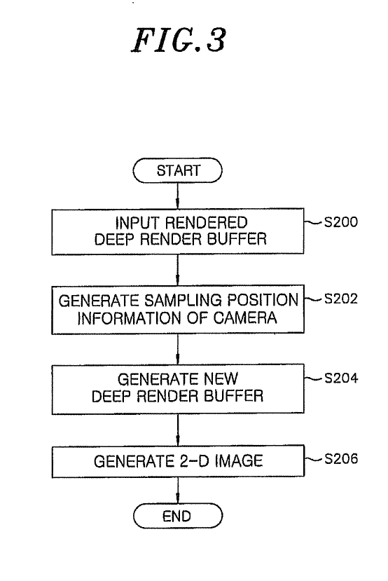

Hereinafter, a data processing method using a rendering system in accordance with another aspect of the present invention will be described in detail with reference to a flow chart given in FIG. 3, along with the constitution of the rendering system described above.

Referring to FIG. 3, the data input unit 100 reads and transmits each node of a deep render buffer at step S200. Once generated are deep render buffer data, for example, the values for the distance, the color and the alpha at each node in the first pixel of the buffer are read in and transmitted to the deep render buffer reconstruction unit 104.

Then in step S202, a new pinhole camera position is calculated by the camera lens sampling unit 102 in which information about sampling position of the camera is generated considering a focal distance and an aperture parameter thereof.

When such deep render buffer information and camera position are given as input, the deep render buffer reconstruction unit 104 generates a new deep render buffer by reconstructing the deep render buffer according to a newly input camera position, in step S204.

Finally in step S206, a 2-D image is generated from the newly reconstructed deep render buffer, and the images generated as many as the number of camera lens sampling are accumulated to represent a DOF effect. Such a process is performed by the render image generation unit 106 and the image accumulation unit 108.

As described above, the present embodiment implements representation of the DOF effect by reconstructing a new deep render buffer according to a new camera sampling position using deep render buffer data generated from hair data rendering and by accumulating those render images generated at the respective camera sampling positions.

While the invention has been shown and described with respect to the particular embodiments, it will be understood by those skilled in the art that various changes and modification may be made without departing from the scope of the invention as defined in the following claims.

1. A rendering system comprising:
a data input unit to read depth information of a deep render buffer obtained by rendering;
a camera lens sampling unit to sample surface data of a lens provided in a camera;
a deep render buffer reconstruction unit to refer to pixel location information of the deep render buffer to reconstruct a deep render buffer at a new camera position, wherein the camera position corresponds to a sampling result from the camera lens sampling unit;
a render image generation unit to generate a render image at the camera position from the reconstructed deep render buffer; and
an image accumulation unit to accumulate the render image at the camera position.

2. The rendering system of claim 1, wherein the camera lens sampling unit samples points on a surface of the lens according to a focal distance and aperture thereof, thereby generating sampling position information of the camera.

3. The rendering system of claim 1, wherein the render image is a two dimensional render image.

4. The rendering system of claim 3, wherein the image accumulation unit generates a depth-of-field render image by accumulating the two dimensional render image.

5. The rendering system of claim 1, wherein the camera is a pinhole camera.
